(19) United States
(12) Patent Application Publication
(10) Pub. No.: US 2023/0186369 A1
(43) Pub. Date: Jun. 15, 2023

(54) SYSTEM AND METHOD FOR OPTIMIZING A PURCHASING EXPERIENCE

(71) Applicant: DEKA Products Limited Partnership, Manchester, NH (US)

(72) Inventors: Karla BEAGLE, Bedford, NH (US); Emily J. MATRUMALO, Londonderry, NH (US); Dean KAMEN, Bedford, NH (US)

(21) Appl. No.: 18/064,019

(22) Filed: Dec. 9, 2022

Related U.S. Application Data
(60) Provisional application No. 63/287,847, filed on Dec. 9, 2021.

(51) Int. Cl. G06Q 30/0601

(52) U.S. Cl. CPC G06Q 30/0631; G06Q 30/0625; G06Q 30/0639; G06Q 30/0641

(57) ABSTRACT

System and method for enabling a shopper to choose products from a myriad of partners who provide special information to help the user choose the right product based on availability, price, and delivery options. The system and method include configuring a partner database, enabling continuous updating of the partner database, and enabling a shopper to choose from a variety of options, and ultimately purchase the product/service through conventional means at the partner's access point.

### CROSS-REFERENCE TO RELATED APPLICATIONS

This application claims the benefit of U.S. Provisional Patent Application Ser. No. 63/287,847 filed Dec. 9, 2021, entitled SYSTEM AND METHOD FOR OPTIMIZING A PURCHASING EXPERIENCE, (Attorney Docket No. AA709), which is incorporated herein by reference in its entirety.

### BACKGROUND

This disclosure relates generally to online browsing and shopping, and more specifically, to achieving the optimum price point and delivery convenience during a shopping experience.

Existing systems calculate coupons and rebates and compare prices of numerous retailer stores to ascertain the lowest price (see Systems, Methods, and Computer Programs for Providing Users Maximum Benefit in Electronic Commerce, WO 2021/141893). A checkout modal window overlays the product landing page. The user chooses from the checkout modal and the purchase is complete without further user interaction. Some systems operate a plurality of online shopping carts using autonomous payments through an authorized payment maker (see Integrated Smart Shopping Cart Operation Method and System for Integrating and Operating Plurality of Online Shopping Mall Carts, WO 2020/262955). Other shopping assistant systems automatically locate discount codes, evaluate them against items selected for purchase, analyze the costs to determine the best result for the user, and apply the discount codes (see Cross-site Online Shopping Assistant, US 2017/0186027). Other systems provide multi-merchant shopping within a web browser. A shared shopping cart can be used for multiple merchants, and options for the desired products can also be selected (see System, Method, and Computer Program for Providing a Multi-Merchant Electronic Shopping Cart for a Shopping Service, AU 2017/202914). In some systems, a webpage exposes remote functionality (e.g. a web service), and a browser extension associated with an application determines whether the application is compatible with the remote functionality (see Exposure of Remotely Invokable Method Through a Webpage to an Application Outside Web Browser, U.S. Pat. U.S. 10,445,159).

When using either Google Search or Google Shopping sites, the Chrome API can provide current location and can determine where the item is. The Google search API or a browser extension can access information from a Google shopping list when a search is performed. Amazon or other retailers provide information that can be used by the shopper to make a shopping decision.

The above-described background is merely intended to provide a contextual overview of some current issues, and is not intended to be exhaustive.

What is needed is a system that allows the user to choose products from a myriad of partners who provide special information to help the user choose the right product based on availability, price, and delivery options.

### BRIEF DESCRIPTION OF THE DRAWINGS

Non-limiting and non-exhaustive aspects of the subject disclosure are described with reference to the following figures, wherein like reference numerals refer to like parts throughout the various views unless otherwise specified.

FIGS. 1-4 (PRIOR ART) are exemplary web browser shopping screens;

FIGS. 5-6 are exemplary web browser extension shopping screens of the present teachings;

FIG. 7 is a protocol diagram of an exemplary configuration of the shopping system of the present teachings;

FIGS. 8A-8B are flowcharts of an exemplary implementation of the shopping system of the present teachings;

FIG. 9 is a schematic block diagram of a first exemplary system of the present teachings; and

FIG. 10 is a schematic block diagram of a second exemplary system of the present teachings.

### DETAILED DESCRIPTION

In the following description, numerous specific details are set forth to provide a thorough understanding of various aspects and arrangements. One skilled in the relevant art will recognize, however, that the techniques described herein can be practiced without one or more of the specific details, or with other methods, components, materials, etc. In other instances, well known structures, materials, or operations may not be shown or described in detail to avoid obscuring certain aspects.

Reference throughout this specification to “an aspect,” “an arrangement,” or “a configuration” indicates that a particular feature, structure, or characteristic is described. Thus, appearances of phrases such as “in one aspect,” “in one arrangement,” “in a configuration,” or the like in various places throughout this specification do not necessarily each refer to the same aspect, feature, configuration, or arrangement. Furthermore, the particular features, structures, and/or characteristics described may be combined in any suitable manner.

To the extent used in the present disclosure and claims, the terms “component,” “system,” “platform,” “layer,” “selector,” “interface,” and the like are intended to refer to a computer-related entity or an entity related to an operational apparatus with one or more specific functionalities, wherein the entity may be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server itself can be a component. One or more components may reside within a process and/or thread of execution and a component may be localized on one computer and/or distributed between two or more computers. In addition, components may execute from various computer-readable media, device-readable storage devices, or machine-readable media having various data structures stored thereon. The components may communicate via local and/or remote processes such as in accordance with a signal having one or more data packets (e.g., data from one component interacting with another component in a local system, a distributed system, and/or across a network such as the Internet with other systems via the signal). As another example, a component can be an apparatus with specific functionality provided by mechanical parts operated by electric or electronic circuitry, which may be operated by a software or firmware application executed by a processor, wherein the processor can be internal or external to the apparatus and executes at least a part of the software or firmware application. As yet another example, a component can be an apparatus that provides specific functionality through electronic components without mechanical parts; the electronic components can include a processor therein to execute software or firmware that confers at least in part the functionality of the electronic components.

To the extent used in the subject specification, terms such as “store,” “storage,” “data store,” data storage,” “database,” and the like refer to memory components, entities embodied in a memory, or components comprising a memory. It will be appreciated that the memory components described herein can be either volatile memory or nonvolatile memory, or can include both volatile and nonvolatile memory.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject disclosure and claims should generally be construed to mean “one or more” unless specified otherwise or clear from context to be directed to a singular form.

The words “exemplary” and/or “demonstrative,” to the extent used herein, mean serving as an example, instance, or illustration. For the avoidance of doubt, the subject matter disclosed herein is not limited by disclosed examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, application data, implicit data, explicit data, etc. Inference can be employed to identify a specific context or action or can generate a probability distribution over states of interest based on a consideration of data and events, for example.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture,” to the extent used herein, is intended to encompass a computer program accessible from any computer-readable device, machine-readable device, computer-readable carrier, computer-readable media, or machine-readable media. For example, computer-readable media can include, but are not limited to, a magnetic storage device, e.g., hard disk; floppy disk; magnetic strip(s); an optical disk (e.g., compact disk (CD), digital video disc (DVD), Blu-ray Disc™ (BD)); a smart card; a flash memory device (e.g., card, stick, key drive); a virtual device that emulates a storage device; and/or any combination of the above computer-readable media.

Generally, program modules include routines, programs, components, data structures, etc., that perform particular tasks or implement particular abstract data types. The illustrated embodiments of the subject disclosure may be practiced in distributed computing environments where certain tasks are performed by remote processing devices that are linked through a communications network. In a distributed computing environment, program modules can be located in both local and remote memory storage devices.

Computing devices can include at least computer-readable storage media, machine-readable storage media, and/or communications media. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media that can be used to store desired information. In this regard, the terms “tangible” or “non-transitory” herein as applied to storage, memory, or computer-readable media, are to be understood to exclude only propagating transitory signals per se as modifiers, and do not exclude any standard storage, memory or computer-readable media that are more than only propagating transitory signals per se.

Computer-readable storage media can be accessed by one or more local or remote computing devices, e.g., via access requests, queries, or other data retrieval protocols, for a variety of operations with respect to the information stored by the medium.

A system bus, as may be used herein, can be any of several types of bus structure that can further interconnect to a memory bus (with or without a memory controller), a peripheral bus, and a local bus using any of a variety of commercially available bus architectures. A database, as may be used herein, can include basic input/output system (BIOS) that can be stored in a non-volatile memory such as ROM, EPROM, or EEPROM, with BIOS containing the basic routines that help to transfer information between elements within a computer, such as during startup. RAM can also include a high-speed RAM such as static RAM for caching data.

As used herein, a computer can operate in a networked environment using logical connections via wired and/or wireless communications to one or more remote computers. The remote computer(s) can be a workstation, server, router, personal computer, portable computer, microprocessor-based entertainment appliance, peer device, or other common network node. Logical connections depicted herein may include wired/wireless connectivity to a local area network (LAN) and/or larger networks, e.g., a wide area network (WAN). Such LAN and WAN networking environments are commonplace in offices and companies, and facilitate enterprise-wide computer networks, such as intranets, any of which can connect to a global communications network, e.g., the Internet.

When used in a LAN networking environment, a computer can be connected to the LAN through a wired and/or wireless communication network interface or adapter. The adapter can facilitate wired or wireless communication to the LAN, which can also include a wireless access point (AP) disposed thereon for communicating with the adapter in a wireless mode.

When used in a WAN networking environment, a computer can include a modem or can be connected to a communications server on the WAN via other means for establishing communications over the WAN, such as by way of the Internet. The modem, which can be internal or external, and a wired or wireless device, can be connected to a system bus via an input device interface. In a networked environment, program modules depicted herein relative to a computer or portions thereof can be stored in a remote memory/storage device.

When used in either a LAN or WAN networking environment, a computer can access cloud storage systems or other network-based storage systems in addition to, or in place of, external storage devices. Generally, a connection between a computer and a cloud storage system can be established over a LAN or a WAN, e.g., via an adapter or a modem, respectively. Upon connecting a computer to an associated cloud storage system, an external storage interface can, with the aid of the adapter and/or modem, manage storage provided by the cloud storage system as it would other types of external storage. For instance, the external storage interface can be configured to provide access to cloud storage sources as if those sources were physically connected to the computer.

As employed in the subject specification, the term “processor” can refer to substantially any computing processing unit or device comprising, but not limited to comprising, single-core processors; single-core processors with software multithread execution capability; multi-core processors; multi-core processors with software multithread execution capability; multi-core processors with hardware multithread technology; vector processors; pipeline processors; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a state machine, discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. For example, a processor may be implemented as one or more processors together, tightly coupled, loosely coupled, or remotely located from each other. Multiple processing chips or multiple devices may share the performance of one or more functions described herein, and similarly, storage may be effected across a plurality of devices.

As an overview, various arrangements are described herein. For simplicity of explanation, the methods are depicted and described as a series of steps or actions. It is to be understood and appreciated that the various arrangements are not limited by the actions illustrated and/or by the order of actions. For example, actions can occur in various orders and/or concurrently, and with other actions not presented or described herein. Furthermore, not all illustrated actions may be required to implement the methods. In addition, the methods could alternatively be represented as a series of interrelated states via a state diagram or events. Additionally, the methods described hereafter are capable of being stored on an article of manufacture (e.g., a machine-readable storage medium) to facilitate transporting and transferring such methodologies to computers.

The description of an exemplary design of the system and method of the present teachings can illustrate its many features. The system and method of the present teachings include a shopper interface, a partner interface, a browser interface, a database interface, and an analysis process. The shopper interface can include a processor executing instructions to provide the shopper with information about desired products and services, and to receive input from the shopper. The partner interface can include a processor executing instructions to receive information from partners that can be used to configure the partner database. Partner information can be added, modified, or deleted, and can be updated periodically or continuously. The partner interface can manage communications between the shopper and the partner access point, for example, to purchase desired goods from the partner. The database interface can include a processor executing instructions to receive partner information and store it in the partner database in a way that is indexed to accommodate the types of searches that will be conducted on the partner database. The database interface processor can execute instructions to receive and store analysis information prepared or otherwise accessed by the system of the present teachings. The analysis processor can execute instructions to prepare the analysis information that can include, but is not limited to including, metrics related to purchases through the system of the present teachings.

A user can take advantage of the features of the present teachings by, for example, augmenting the capabilities of a commercially-available web browser, adding the features to a custom-developed web browser, or modifying a search engine to include the features. In the description herein, an exemplary implementation is described in which the capabilities of a commercially-available web browser are extended. The system and method of the present teachings are not limited to such an implementation. One of ordinary skill in the art could develop the system and method in one of many ways. In an aspect, the system and method of the present teachings includes components that interface with participating partners and components that interface with web browser displays. Partners can include vendors that sell products and services that can be found at least through an internet search engine search. Potential partners can interface with the system of the present teachings to become affiliated with others who desire to team up to present their products and services through the system of the present teachings. When a shopper takes advantage of the system of the present teachings, and the shopper has selected a product or service from a conventional web search, the system of the present teachings will present options for the product or service from the partners' inventory. The system will also analyze information provided by the partners and possibly gathered elsewhere, and provide the analyzed information in a form that is especially useful and sortable to the shopper. Analyzed information can include, but is not limited to including, the location of the partner, possibly relative to the shopper, the estimated delivery date and cost of the product or service, the directions to the partner, reviews of the product or service ranked relative to other choices from other of the partners, and a recommended of the products or services based on, for example, but not limited to, a default ranking system, a shopper-specified ranking system, or a dynamically-determined ranking system established by the shopper's shopping history. In the end, the shopper can select a product or service based on the analyzed information and the partner can receive heightened attention to its product or service.

One possible implementation is a browser extension. Browser extensions are software source code modules that add custom features to internet browsers such as, for example, but not limited to, Chrome, Firefox, Safari, Internet Explorer, Microsoft Edge, Opera, Brave, Chromium, Vivaldi, Tor, Mosaic, Maxthon, Netscape Navigator, UC Browser, SeaMonkey, Pale Moon, Epic, Firefox Focus, Flock, and many others. Typical extensions include user interface modifications, cookie management, ad blocking, and styling of web pages. Although there is currently no standard applications programming interface (API) for extensions, the APIs across current browsers are similar to the Chrome API, which is publically available. With the Chrome API, among other things, a browser extension can take actions that depend on the content of a page without requiring reading the content of the page. The Chrome API also provides a means for a browser extension to capture content of a screen, individual windows, or tabs, and interact with a window by evaluating code in the context of the window, reload a page, or obtain a list of resources within the page. Further, the Chrome API provides a means to retrieve the background page, and listen for and respond to events in the application running on the background page. Still further, the Chrome API allows software developers to examine names, roles, states, events, and nodes of a page.

A modal window is a graphical user interface element that is subordinate to a main user interface window, but creates a mode in which the main window is disabled but visible, with the modal window is in front of the main window. The user must interact with the modal window to get back to the main window. Modal windows draw attention to particular pieces of information, collect application options, showing detail of images in the main window, or display ads when the cursor hovers over a part of the main window. Modal windows can be created by a browser extension.

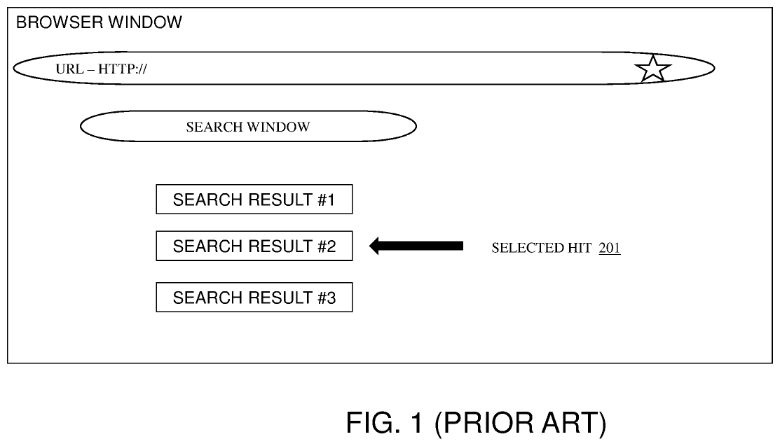

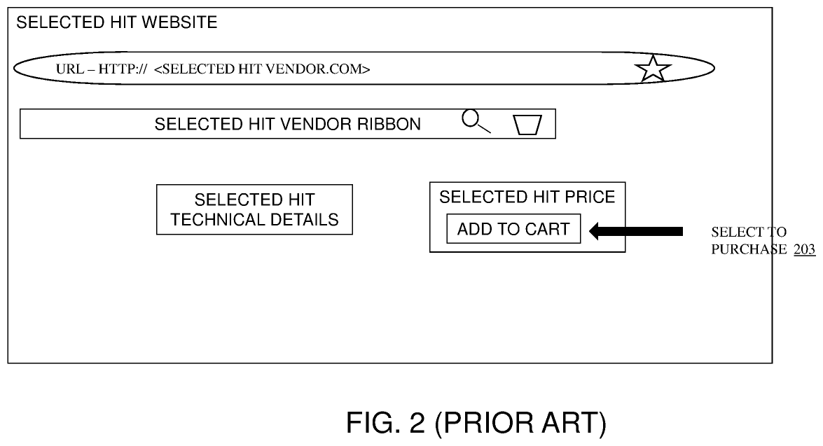

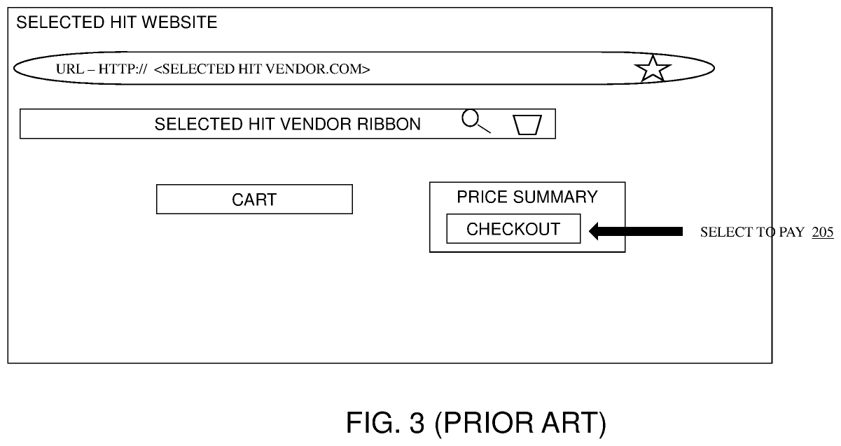

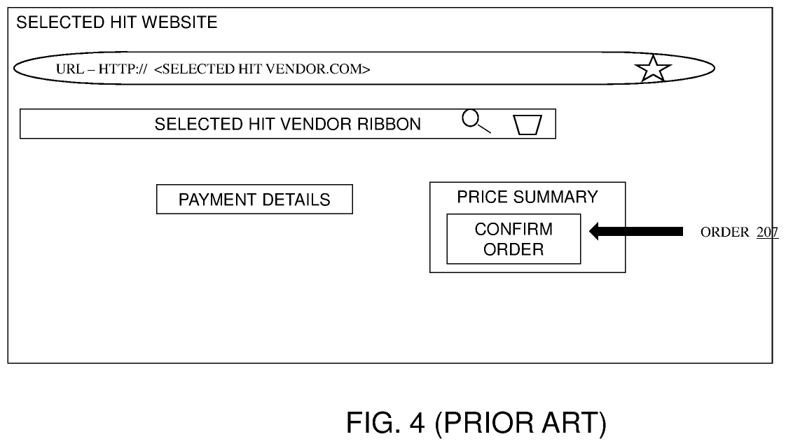

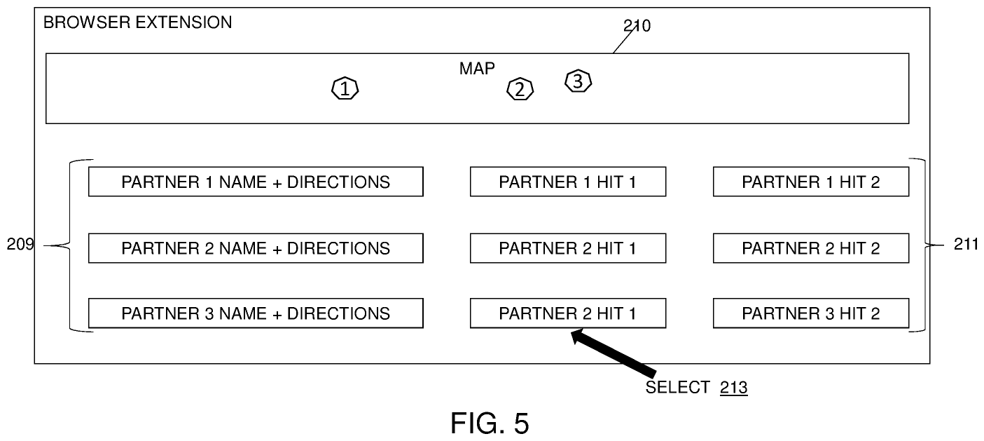

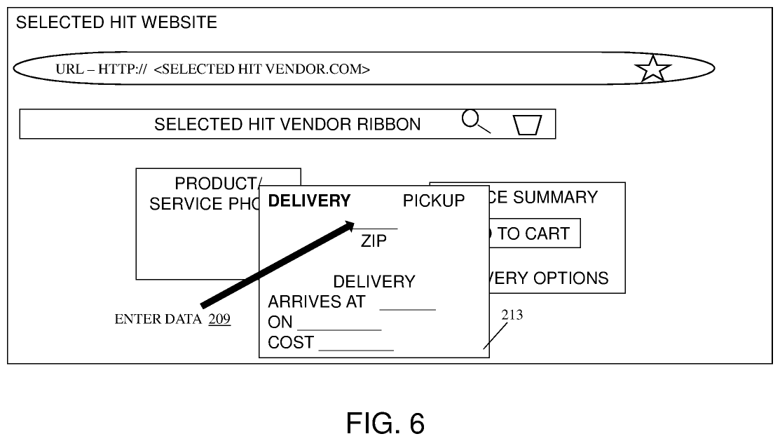

Referring now to FIGS. 1-4 (PRIOR ART) and FIGS. 5-6, an example illustrates the features of the system and method of the present teachings. In FIG. 1 (PRIOR ART), an exemplary conventional shopping search can provide a page that includes, for example, a list of results. Results can include, for example, but not limited to, products and services. Exemplary services include professional services, restaurants, home repair services, retail and wholesale services, and many others. Each of the results is linked to, for example, the vendor's page associated with the result. The list of results can be accompanied by result information, including result name, vendor, price, delivery options, and reviews. The user can select 201 (FIG. 1 (PRIOR ART)) a desired result from the list. FIG. 2 (PRIOR ART) illustrates that the desired result's details can be displayed along with product details and a link 203 (FIG. 2 (PRIOR ART)) to the vendor's cart. In FIG. 3 (PRIOR ART), when the shopper chooses to go to the cart, the cart is displayed and the user has the option to choose to pay 205 (FIG. 3 (PRIOR ART)) for the product or service. FIG. 4 (PRIOR ART) illustrates another step in the shopping process, confirming 207 (FIG. 4 (PRIOR ART)) the order.

Referring now to FIG. 5, when the shopper confirms the order, the system of the present teachings, possibly implemented as a browser extension associated by the shopper with the web browser that the shopper is using, can take control of the ordering process and display options, with respect to the desired product or service, that are associated with partner vendors 209. In some configurations, partner vendors 209 can be listed along with products/services 211 offered by partner vendors 209 that are the same as or similar to the desired product. In some configurations, locations of partners 209 can be displayed. The display can include map 210 with hot spots that are linked to the partner's display so that when the shopper selects the partner, the location of the partner is shown on the map. Directions can be provided from the shopper's location to the partner. These features can be provided by conventional means or by custom implementations. For example, conventional mapping means can include GOOGLE Maps that can be accessed by the browser extension to display the map, determine distances, and provide other conventional electronic mapping features. In some configurations, the browser extension can access information provided by the partner, either publically-available information or information available by special agreement, and can present that information alongside the product or service. The information can be gathered in real-time or historically-maintained. This is one of the features that the special access provided by the partners affords to the shopper. For example, current shopper traffic within the vendor's establishment, number of the desired products there are left on the shelves, the total difference in price between user-pickup and vendor delivery, the cost to hire non-vendor delivery (including tip), and the availability window of non-vendor delivery can all be available and displayed to the shopper to help the shopper decide whether to purchase, and how to obtain the product or service after the transaction has completed. Further, the information in the partner database, and therefore available to the shopper, can be dynamically updated so that the shopper can make highly-informed shopping decisions. Some partners may be able to provide a myriad of information based on in-house sensors, customer service data gathering requirements, and other sources. Other partners may be able to provide a subset of the full spectrum of information. During the partner configuration stage, the partner can choose which types of information can be available to the shopper, and how frequently the information will update the partner database. Further, shoppers can be self-sorted or otherwise so that certain information will be provided to some shoppers, while other information will be provided to other shoppers. Still further, the system of the present teachings can provide shopping metrics to the partners, for example, metrics related to the types of goods/services purchased, the frequency of purchase, the preferences of shoppers using the system of the present teachings, either anonymously or not, and suggestions for improving outreach to customers associated with the partner database based, for example, on other information gathered about the shoppers. From partner hit list 211, a product/service from partner 209 can be selected 113.

Referring now to FIG. 6, the browser extension can invoke the partner's access point, such as, for example, but not limited to, a website page, that includes the selected product/service. The partner's access point can appear in any number of ways, but usually includes a photo of the product or service, a summary of the purchase, cost, and delivery options. The partner's display format does not change the actions of the browser extension because the browser extension provides its additional value through a pop-up window or modal window or any other screen capture capability. The system of the present teachings can, for example, overlay modal window 213 upon the partner's information as shown. The modal window can include selections that the system of the present teachings can allow the user to make. For example, the system can display delivery options — for example, arrival time and cost — and can give the user the opportunity to update her/his location. The system can give the user the option to pick up the product. Other options, such as a third party transport company, can be presented to the user as a possible selection. For example, an autonomous delivery vehicle can be summoned to retrieve the product and deliver it to the user. The system of the present teachings can be configured to present any item available from the partner to the shopper, for example, in modal window 213. After the shopper answers the prompts of the system of the present teachings, the system performs handshaking with the partner to complete the setup for the sale. The partner access point is provided to the shopper, and the shopper can complete the transaction through the partner access point.

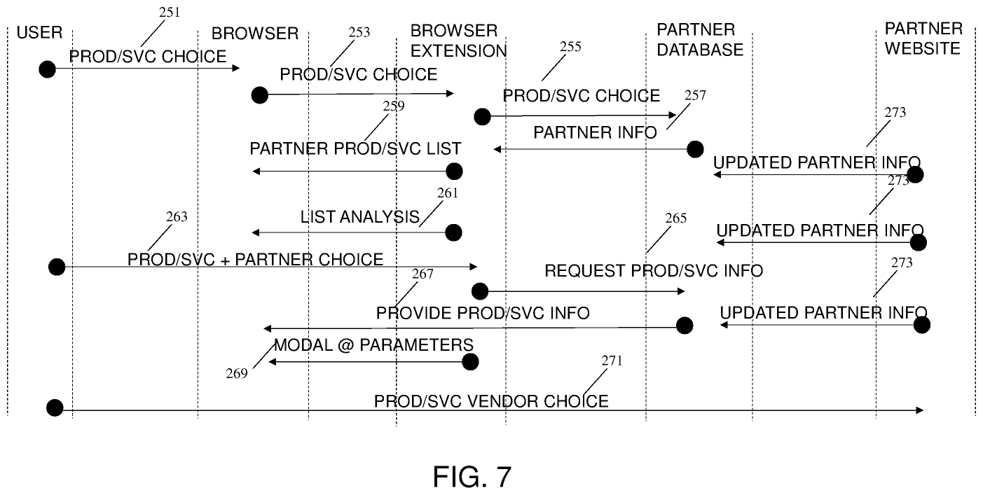

Referring now to FIG. 7, an exemplary protocol of the system of the present teachings is shown. Prior to the invocation of the system of the present teachings by a shopper's selections, a partner database is configured, possibly by the system of the present teachings itself. The system of the present teachings can access a list of partners, determine the partner's access method, and populate the database itself. Partner information can be accessed by an applications programming interface (API), direct access to partner data, or data/code share agreements between parties. If APIs are used, the APIs can be publically or privately available. The type of API that the partners provide can include, but is not limited to including, an open API and/or a partner API. Open APIs, or public APIs, available for use by anyone, typically have few to no security guardrails, and usually a reduced amount of the partner's data can be accessed by public APIs. Partner APIs are shared by entities that are parties to some form of contract that sets the terms of use of the API. Because access is limited, security features are stronger. Possible API architectures include, but aren't limited to including, representational state transfer (REST), simple object access protocol (SOAP), and remote procedure call (RPC). The REST protocol is used for transferring data from a server to a client. The REST protocol requires use of the HTTP communication protocol and the JSON data interchange format. The SOAP protocol is used for transmitting data across networks. The SOAP protocol requires strictly-defined XML formatted messages, providing a higher level of security than the REST protocol. The SOAP protocol works over any communications protocol. The RPC protocol executes scripts on a server, using JSON or XML formats. The system of the present teachings can use either open or partner APIs, depending at least upon the preference of the partner and security requirements. For example, any sharing of consumer information among partners could require the enhanced security of the SOAP protocol.

Likewise, the system of the present teachings can publish an API that the partners can use to manage their parts of the partner database. Regardless of how the partner database is originally constructed, changes to the database are allowed to be made by both the system of the present teachings and the partner. Thus, the system of the present teachings must provide a way for the partners to access the partner database. If an API is chosen, the structure of the arguments of the API functions depend on the contents of the partner database. A required list of commands for interacting with the partner database through the system of the present teachings can include, but is not limited to, add/update/remove partner, add/update/remove access point, add/update/remove product/service, and add/update/remove shopping feature associated with each product/service. The partner database includes at least one way for the shopper to contact the partner access point and purchase goods and services at the access point. The partner database can also include special features offered by the partner. An exemplary partner database record can include partner name, partner access point, a list of partner product/services, and a list of partner product/service features. Exemplary partners include Walmart, Sam's Club, CVS, and Target. Exemplary products include televisions, clothing, and medications. Exemplary services include automotive repair, salons, and restaurants. Exemplary features can include locations where the product is in stock, locations that can provide information about how many products of the desired type remain in the store for purchase, delivery options, possible delivery dates/times, shopper traffic monitoring in the store and parking lot, and other information to assist the shopper in deciding whether and when to purchase the product or service, and from whom.

Continuing to refer to FIG. 7, after the partner database is configured and populated, the system of the present teachings can be made available for shoppers. For example, if the system is implemented as a browser extension, the shopper can search for the extension and integrate it with the shopper's browser through conventional means. When the extension is integrated with the shopper's browser, the extension is invoked, as shown in FIG. 7, when the shopper performs a conventional web search for a desired product/service, selects a desired product/service, and navigates through the purchase process on a vendor access point. The system of the present teachings can be invoked at any point in the shopper's process. When the shopper has reached the point 251 in the purchase process of committing funds to the vendor to purchase the product/service, the system of the present teachings can provide 253 the shopper's product/service choice to query 255 the partner database to search for the shopper's desired product/service in the partner database. The system of the present teachings can receive 257 the partner data and can format the partner data and supply 259 the data to the browser. The system can also analyze the partner data based on partner-provided parameters. For example, delivery information can be updated based upon the capabilities provided by the partner to update such data. For example, shelf availability and store traffic can be assessed. The various types of partner data can be weighed against each other to establish a preferred vendor based upon a ranking of criteria supplied by the shopper, or a default ranking, or a dynamically-determined ranking based on other shopper visits to the browser extension, or a combination. As an example of dynamically-determined ranking, if the shopper consistently values store pickup over delivery, the system of the present teachings provides extra analysis weight to partners with pickup locations in the vicinity of the shopper's current, expected, or desired delivery location (which may not be the shopper's home or office, and may in fact be where the shopper is standing on the sidewalk, for example). The system can provide 261 the analysis for the browser to display, and the shopper to inspect. The shopper can inspect the data through conventional means, for example, sorting, and can review the analysis list of products/services that the system of the present teachings has provided 263 as optimum choices for the shopper. Ultimately, the shopper can select a product/service from the list of partners' product/services. Note that the partners' products/services list may include products/services that are similar but not identical to the product/service that was initially selected for purchase before the system of the present teachings made the partners' list available to the shopper. The partners have complete flexibility over the response to the initial query of the partner's database. Further, the partner can periodically update 273 the partner database with new, modified, or expunged information. Updates can also be continuous, or communications between the partner and the partner database can be limited to when there are changes that the partner believes are worthy of changing. When the shopper has selected a product/service from the partner list, the system requests 265 product/service information from the partner database, and the partner database provides 267 product/service information to the browser for the shopper to inspect. Further, the system of the present teachings displays 269 a modal window with analysis-specific queries. For example, for a partner providing a myriad of delivery and pickup options, the modal window collects information from the shopper that is required to implement the customized delivery. Ultimately, the shopper enters all the necessary data and those data are shipped 271 to the partner to initiate the purchase and delivery. Product/service information can be displayed on any type of monitor, including handheld, tablet, desktop display, or laptop, for example. If, for the shopper, a display is not useful, the system of the present teachings can provide the product/service information and other useful information in the form of a log file, possibly encoded in Braille or an audio log for visually-impaired shoppers.

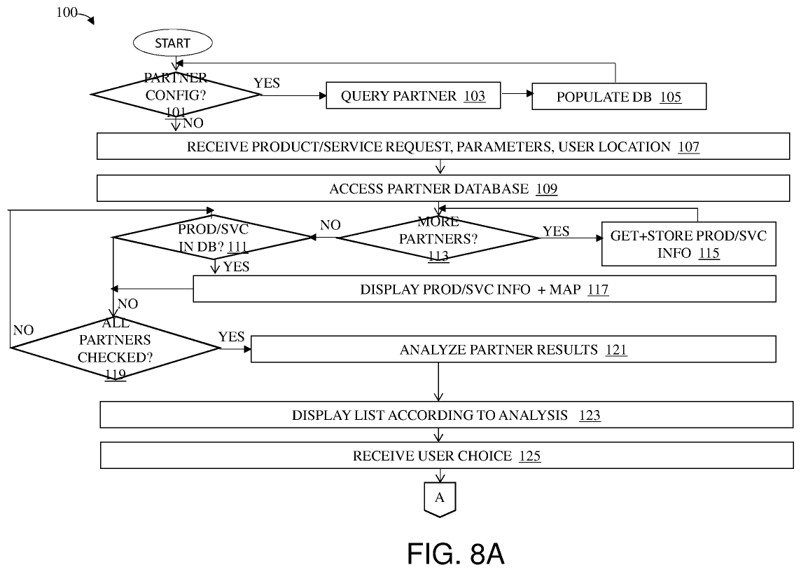

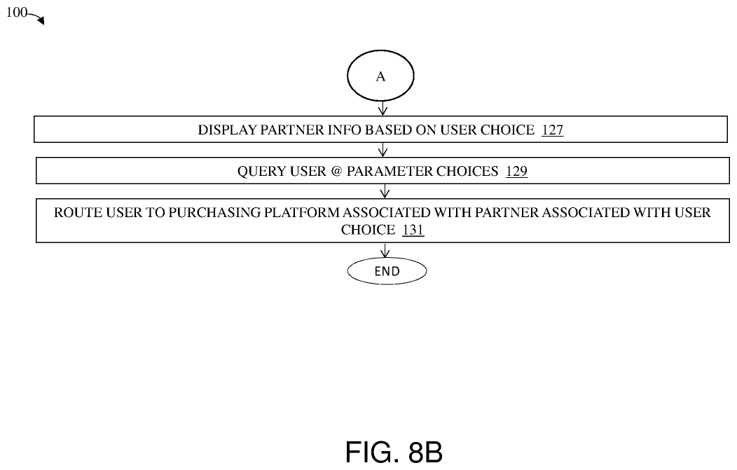

Referring now to FIGS. 8A-8B, method 100 for enhancing a shopper's experience by providing information and analysis customized for the shopper from a select group of vendors can include, but is not limited to including, configuring a partner database, capturing user input through a captive browser means, and using the captive browser means to manage the shopping experience for the shopper. Method 100 can include, but is not limited to including, in response to a partner request, configuring 101 a partner's information if the partner is not already in the partner database, or updating the partner information if the partner is in the database, by querying 103 the partner and populating 105 the database based on the query. Method 100 can include receiving 107 a product/service request from a shopper, invoking a browser extension, with the shopper's approval, and accessing 109 the populated partner database. For all partners 113 that have included data in the partner database that is relevant to the query, method 100 can include accessing 115 product/service data, and if 111 there is information about the desired product/service in the database (even related products/services), method 100 can include providing 117 product/service data. When 119 all partners' data have been queried and provided, method 100 can analyze 121 the query results and display 123 the results according to the analysis. Method 100 can include receiving 125 the shopper's selection, providing 127 further product/service information based on the selection, displaying a query window, possibly atop the product/service information, querying 129 for partner/shopper-specific information related to the product/service, partner options, and shopper preferences, returning 131 the shopper to the partner access point, where the shopper can make a purchase choice at the partner access point.

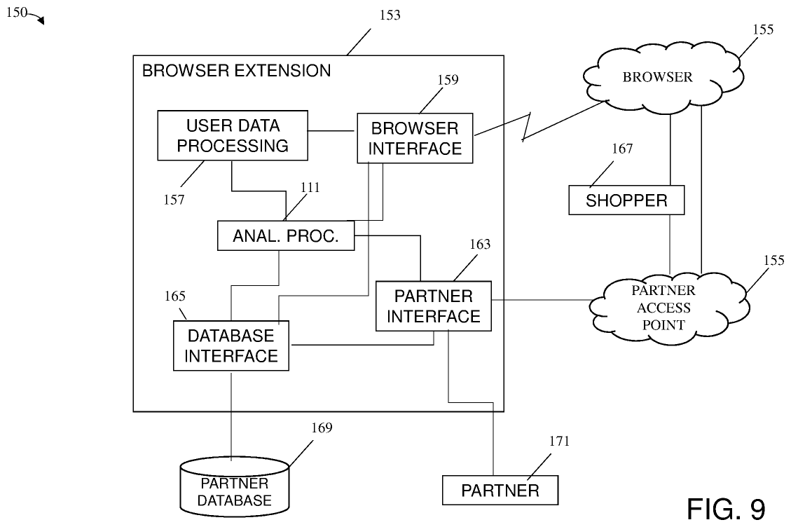

Referring now to FIG. 9, system 150 for enhancing a shopper's experience by providing information and analysis customized for the shopper from a select group of vendors can include, but is not limited to including, browser extension 153 configuring partner database 169 and managing the shopping experience for shopper 167. User data processing 154 can manage input from and output to shopper 167. System 150 can include, but is not limited to including, partner interface 163 implemented by a processor executing instructions, in response to a partner request, to configure a partner's information in partner database 169 through database interface 165. Partner interface 163 can also include instructions that can update partner information in partner database 169 if partner interface 163 has queried partner access point 155 and found changes from data in partner database 169. System 150 can include browser interface 159 executing instructions for receiving a product/service request from shopper 167, and, when a browser capture facility such as a browser extension is activated, for accessing partner database 155. The browser capture facility, part of browser interface 159, can retain control during the shopping process until the shopper begins the payment process at partner access point 155. For all partners 171 that offer products/services requested by shopper 167, database interface 165 can execute instructions to access product/service data from partner database 169, and if there is information about the desired product/service in partner database 169, browser interface 159 can execute instructions to display the product/service data. When all partners 171 have been queried and all information from partner database has been displayed, analysis processor 111 can execute instructions to analyze the query results and provide the results to browser interface 159 to display. Browser interface 159 can execute instructions to receive the selection from shopper 167, and display product/service information based on the selection. Browser interface 159 can execute instructions through, for example, a modal window or other similar means such as slides, accordions, expanding panes, or enhanced tooltips, query shopper 167 for partner/shopper-specific information related to the product/service, partner options, and shopper preferences, and can enable, according to the received information and option choices, a purchase by shopper 267 at partner access point 155.

The partner database can be indexed in many ways to set up security barriers and for ease and speed of access, among other organizational reasons. Individual shoppers can have access controlled by creating user groups Likewise, individual partners can be prevented from accessing other partners' areas of the database. Access for modification can be strictly controlled to avoid data corruption.

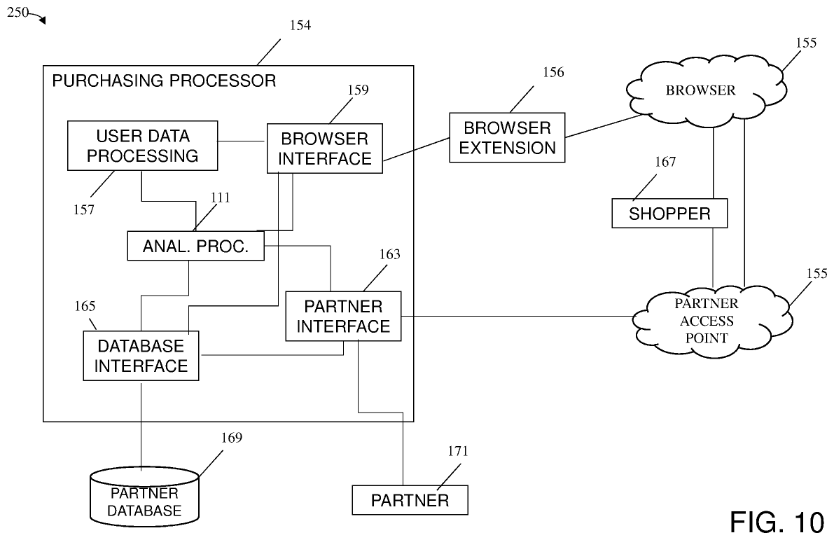

Referring now to FIG. 10, system 250 can include browser extension 156 that is invoked because the shopper has selected to include the extension in her browsing experience, and when the shopper invokes the extended browser. In some configurations, browser extension 156, when invoked, presents a user interface which captures data entered into the browser by the shopper. The data are then shipped to purchasing processor 154 which handles the protocol set out in FIG. 7 and described in part in the description of FIG. 9.

In an aspect, the method of the present teachings for enhancing an experience by a shopper by providing information and analysis customized for the shopper from at least one partner can include, but is not limited to including, configuring a partner database with partner data from the at least one partner, configuring at least one browser with a browser extension, the browser extension providing an option to the shopper for accessing the partner database, receiving, by the browser extension at least one desired product/service from the shopper, and redirecting, by the browser extension, a product/service data query from an access point of the at least one partner to the partner database. If there is information related to the desired product/service in the partner database, the method can include providing the desired product/service data to the shopper, analyzing the desired product/service data and providing the analyzed data to the shopper, receiving at least one selection from the desired product/service data from the shopper, providing information related to the selected product/service at least from the partner database, and receiving a purchase choice from the shopper.

In an aspect, the at least one browser can include a commercially-available web browser. In an aspect, the method can include initiating the purchase choice at an access point associated with the partner. The partner database can include a data storage device local to the shopper and/or a cloud database. The partner database can include the product/service data associated with the at least one partner, and/or at least one partition separating a first set of the product/service data associated with a first of the at least one partner from a second set of the product/service data associated with a second of the at least one partner. The at least one partition can include a security barrier. The partner database can include ranks of the product/service data and/or analysis of the product/service data based on cost, benefit to the at least one partner, modes of delivery, and proximity to the shopper. Providing the desired product/service to the shopper can include storing the desired product/service in a shopper-specific database, and/or displaying the desired product/service, and/or providing an audio description of the desired product/service.

In an aspect, the system of the present teachings for enhancing an experience by a shopper by providing information and analysis customized for the shopper from at least one partner can include, but is not limited to including, at least one processor executing instructions for configuring a partner database with partner data from the at least one partner, receiving at least one desired product/service from the shopper, accessing product/service data from the partner database, if there is information related to the desired product/service in the partner database, providing the desired product/service data to the shopper, analyzing the desired product/service data and providing the analyzed data to the shopper, receiving at least one selection from the desired product/service data from the shopper, providing information related to the selected product/service at least from the partner database, and receiving a purchase choice from the shopper.

In an aspect, the system can include further instructions for receiving, from the shopper, selections of partner/shopper-specific information related to the product/service, partner options, and shopper preferences, and/or initiating the purchase choice at an access point associated with the partner. The partner database can include a data storage device local to the shopper, and/or a cloud database, and/or the product/service data associated with the at least one partner, and/or at least one partition separating a first set of the product/service data associated with a first of the at least one partner from a second set of the product/service data associated with a second of the at least one partner. In an aspect, the at least one partition includes a security barrier. The partner database can include ranks of the product/service data, and/or analysis of the product/service data based on cost, benefit to the at least one partner, modes of delivery, and proximity to the shopper. In an aspect, the system can include instructions for storing the desired product/service in a shopper-specific database, and/or displaying the desired product/service, and/or providing an audio description of the desired product/service, and/or receiving, from the shopper, the at least one selection of partner/shopper-specific information related to the product/service from a modal window, and/or receiving, from the shopper, the at least one selection of partner/shopper-specific information related to the product/service from a modal window.

In an aspect, the method of the present teachings for enhancing an experience by a shopper by providing information and analysis customized for the shopper from at least one partner can include, but is not limited to including, configuring a partner database with partner data from the at least one partner, receiving at least one desired product/service from the shopper, and accessing product/service data from the partner database. If there is information related to the desired product/service in the partner database, the method can include providing the desired product/service data to the shopper, analyzing the desired product/service data and providing the analyzed data to the shopper, receiving at least one selection from the desired product/service data from the shopper, providing information related to the selected product/service at least from the partner database, and receiving a purchase choice from the shopper.

In an aspect, the method as can include receiving, from the shopper, selections of partner/shopper-specific information related to the product/service, partner options, and shopper preferences.

Those of skill in the art would understand that information and signals may be represented using any of a variety of different existing techniques. For example, data, instructions, commands, information, signals, bits, symbols, or chips that may be referenced throughout the description may be represented by voltages, currents, electromagnetic waves, magnetic fields or particles, optical fields or particles, ultrasonic waves, projected capacitance, or any combination thereof.

Those of skill would further appreciate that the various illustrative logical blocks, modules, circuits, and method steps described in connection with the arrangements disclosed herein may be implemented as electronic hardware, computer software, or combinations of both. To clearly illustrate this interchangeability of hardware and software, various illustrative components, blocks, modules, circuits, and steps have been described in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the appended claims.

The various illustrative logical blocks, modules, and circuits described in connection with the arrangements disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The actions of a method described in connection with the arrangements disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC. The ASIC may reside in functional equipment such as, e.g., a computer, a robot, a user terminal, a mobile telephone or tablet, a car, or an IP camera. In the alternative, the processor and the storage medium may reside as discrete components in such functional equipment.

The above description is not intended to be exhaustive or to limit the features to the precise forms disclosed. Various alternatives and modifications can be devised by those skilled in the art without departing from the disclosure, and the generic principles defined herein may be applied to other aspects without departing from the spirit or scope of the appended claims. Accordingly, the present disclosure is intended to embrace all such alternatives, modifications and variances. Additionally, while several arrangements of the present disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as examples of particular configurations. And those skilled in the art will envision other modifications within the scope and spirit of the claims appended hereto. Other elements, steps, actions, methods, and techniques that are not substantially different from those described above and/or in the appended claims are also intended to be within the scope of the disclosure. Thus, the appended claims are not intended to be limited to the arrangements shown and described herein, but are to be accorded the broadest scope consistent with the principles and novel features disclosed herein.

The arrangements shown in drawings are presented only to demonstrate certain examples of the disclosure. And, the drawings described are merely illustrative and are non-limiting. In the drawings, for illustrative purposes, the size of some of the elements may be exaggerated and not drawn to a particular scale. Additionally, elements shown within the drawings that have the same numbers may be identical elements or may be similar elements, depending on the context.

Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. Furthermore, to the extent that the terms “includes,” “has,” “possesses,” and the like are used in the present description and claims, such terms are intended to be inclusive in a manner similar to the term “comprising,” as “comprising” is interpreted when employed as a transitional word in a claim.

Furthermore, the terms “first”, “second”, “third” and the like, whether used in the description or in the claims, are provided to distinguish between similar elements and not necessarily to describe a sequential or chronological order. It is to be understood that the terms so used are interchangeable under appropriate circumstances (unless clearly disclosed otherwise) and that the aspects of the disclosure described herein are capable of operation in other sequences and/or arrangements than are described or illustrated herein.

What is claimed is:

1. A method for enhancing an experience by a shopper by providing information and analysis customized for the shopper from at least one partner, the method comprising:
configuring a partner database with partner data from the at least one partner;
configuring at least one browser with a browser extension, the browser extension providing an option to the shopper for accessing the partner database;
receiving, by the browser extension, at least one desired product/service from the shopper;
redirecting, by the browser extension, a product/service data query from an access point of the at least one partner to the partner database;
if there is information related to the at least one desired product/service in the partner database, providing desired product/service data to the shopper;
analyzing the desired product/service data and providing the analyzed data to the shopper;
receiving at least one selection from the desired product/service data from the shopper;
providing information related to the selection product/service at least from the partner database; and
receiving a purchase choice from the shopper.

2. The method as in claim 1 wherein the at least one browser comprises:
a commercially-available web browser.

3. The method as in claim 1 comprising:
initiating the purchase choice at the access point associated with the at least one partner.

4. The method as in claim 1 wherein the partner database comprises:
a data storage device local to the shopper.

5. The method as in claim 1 wherein the partner database comprises:
a cloud database.

6. The method as in claim 1 wherein the partner database comprises:
the product/service data associated with the at least one partner.

7. The method as in claim 1 wherein the partner database comprises:
at least one partition separating a first set of the product/service data associated with a first of the at least one partner from a second set of the product/service data associated with a second of the at least one partner.

8. The method as in claim 7 wherein the at least one partition comprises:
a security barrier.

9. The method as in claim 1 wherein the partner database comprises:
ranks of the product/service data.

10. The method as in claim 1 wherein the partner database comprises:
analyzed data of the product/service data based on cost, benefit to the at least one partner, modes of delivery, and proximity to the shopper.

11. The method as in claim 1 wherein the providing the at least one desired product/service to the shopper comprises:
storing the at least one desired product/service in a shopper-specific database.

12. The method as in claim 1 wherein the providing the at least one desired product/service to the shopper comprises:
displaying the at least one desired product/service.

13. The method as in claim 1 wherein the providing the at least one desired product/service to the shopper comprises:
providing an audio description of the at least one desired product/service.

14. A system for enhancing an experience by a shopper by providing information and analysis customized for the shopper from at least one partner, the system comprising:
at least one processor executing instructions for:
configuring a partner database with partner data from the at least one partner;
receiving at least one desired product/service from the shopper;
accessing product/service data from the partner database;
if there is information related to the at least one desired product/service in the partner database, providing the desired product/service data to the shopper;
analyzing the desired product/service data and providing the analyzed data to the shopper;
receiving at least one selection from the desired product/service data from the shopper;
providing information related to the selection at least from the partner database; and
receiving a purchase choice from the shopper.

15. The system as in claim 14 wherein the instructions further comprise:
receiving, from the shopper, selections of partner/shopper-specific information related to the at least one desired product/service, partner options, and shopper preferences.

16. The system as in claim 14 wherein the instructions further comprise:
initiating the purchase choice at an access point associated with the at least one partner.

17. The system as in claim 14 wherein the partner database comprises:
a data storage device local to the shopper.

18. The system as in claim 14 wherein the partner database comprises:
a cloud database.

19. The system as in claim 14 wherein the partner database comprises:
the product/service data associated with the at least one partner.

20. The system as in claim 14 wherein the partner database comprises:
at least one partition separating a first set of the product/service data associated with a first of the at least one partner from a second set of the product/service data associated with a second of the at least one partner.

21. The system as in claim 20 wherein the at least one partition comprises:
a security barrier.

22. The system as in claim 14 wherein the partner database comprises:
ranks of the product/service data.

23. The system as in claim 14 wherein the partner database comprises:
analyzed data of the product/service data based on cost, benefit to the at least one partner, modes of delivery, and proximity to the shopper.

24. The system as in claim 14 wherein the providing the at least one desired product/service to the shopper comprises instructions for:
storing the at least one desired product/service in a shopper-specific database.

25. The system as in claim 14 wherein the providing the at least one desired product/service to the shopper comprises instructions for:
displaying the at least one desired product/service.

26. The system as in claim 14 wherein the providing the at least one desired product/service to the shopper comprises instructions for:
providing an audio description of the at least one desired product/service.

27. The system as in claim 14 wherein the instructions further comprise:
receiving, from the shopper, the at least one selection of partner/shopper-specific information related to the at least one desired product/service from a modal window.

28. The system as in claim 14 wherein the instructions further comprise:
receiving, from the shopper, the at least one selection of partner/shopper-specific information related to the at least one product/service from a modal window.

29. A method for enhancing an experience by a shopper by providing information and analysis customized for the shopper from at least one partner, the method comprising:
configuring a partner database with partner data from the at least one partner;
receiving at least one desired product/service from the shopper;
accessing product/service data from the partner database;
if there is information related to the at least one desired product/service in the partner database, providing the desired product/service data to the shopper;
analyzing the desired product/service data and providing the analyzed data to the shopper;
receiving at least one selection from the desired product/service data from the shopper;
providing information related to the selection at least from the partner database; and
receiving a purchase choice from the shopper.

30. The method as in claim 29 further comprising:
receiving, from the shopper, selections of partner/shopper-specific information related to the at least one product/service, partner options, and shopper preferences.
